(19) United States
(12) Patent Application Publication
(10) Pub. No.: US 2026/0211354 A1
(43) Pub. Date: Jul. 23, 2026

(54) SEAL MEMBER, TONER CARRYING DEVICE PROVIDED WITH THE SEAL MEMBER, AND IMAGE FORMING APPARATUS

(71) Applicant: CANON KABUSHIKI KAISHA, Tokyo (JP)

(72) Inventor: YU FUKASAWA, Tokyo (JP)

(21) Appl. No.: 19/567,529

(22) Filed: Mar. 16, 2026

Related U.S. Application Data
(63) Continuation of application No. PCT/JP2024/080131, filed on Aug. 2, 2024.

(30) Foreign Application Priority Data
Sep. 28, 2023 (JP) 2023-166834

(51) Int. Cl. G03G 15/08; C10M 103/00; C10M 105/24; C10M 107/50; C10N 40/14; C10N 50/08; D01F 1/10; D01F 6/18; D01F 6/60; D01F 6/62; D02G 3/02; D06M 11/80; D06M 101/32; G03G 15/00; G03G 15/01

(52) U.S. Cl. CPC G03G 15/0817; C10M 103/00; C10M 105/24; C10M 107/50; D01F 1/10; D01F 6/18; D01F 6/60; D01F 6/62; D02G 3/02; D06M 11/80; G03G 15/751; C10M 2201/003; C10M 2207/126; C10M 2229/025; C10N 2040/14; C10N 2050/08; D06M 2101/32; D06M 2200/40; D10B 2321/08; D10B 2331/02; D10B 2331/04; D10B 2505/00; G03G 15/0121; G03G 15/0189

(57) ABSTRACT

A drum unit 8 applicable to an image forming apparatus 500 includes a photosensitive drum 4 rotatable and constituted so as to carry toner, a cleaning container 15 for rotatably supporting the photosensitive drum 4, and an end portion seal 300 for sealing a gap between an end portion of the photosensitive drum 4 in a longitudinal direction of the photosensitive drum 4 and the cleaning container 15, wherein the end portion seal 300 includes a fiber surface layer 401 rubbing the photosensitive drum 4, and wherein the fiber surface layer 401 contains a lubricant containing fiber yarn 404 to which particles of a solid lubricant are fixed.

### TECHNICAL FIELD

The present invention relates to a seal member, a toner carrying device provided with the seal member, and an image forming apparatus. For example, the present invention relates to the seal member used in an electrophotographic image forming apparatus, such as a copying machine or a printer, employing an electrophotographic process, and the toner carrying device provided with the seal member.

### BACKGROUND ART

In a conventional image forming apparatus of the electrophotographic process, toner supply and maintenance of various process means are needed, and in order to facilitate the toner supply and the maintenance, a photosensitive drum, a charging means, a developing means, a cleaning means, and the like are integrally assembled into a cartridge in a frame. The assembled cartridge is put into practice use as a process cartridge detachably mountable to an image forming apparatus main body (main assembly). According to the cartridge type, maintenance of the apparatus can be performed by a user himself(herself), so that operability can be improved and it is possible to provide an image forming apparatus excellent usability. For that reason, this cartridge type has been widely used in the image forming apparatus. The process cartridge is generally constituted by a drum unit including the photosensitive drum and a developing unit for supplying a developer to the photosensitive drum.

The drum unit is provided with the photosensitive drum, a charging roller for electrically charging the photosensitive drum, a cleaning member for collecting toner (residual toner) remaining on the photosensitive drum by scraping the toner from the photosensitive drum, and a cleaning container for supporting the photosensitive drum, the charging roller, and the cleaning member. In the drum unit, in order to prevent leakage of the toner accommodated in the cleaning container to an outside, the drum unit employs a constitution for sealing the drum unit with a plurality of seal members. For example, in a gap between the cleaning container, the photosensitive drum, and the cleaning member, as the seal members for opposite end portions of the photosensitive drum with respect to a longitudinal direction of the photosensitive drum, cleaning-side end portion seals are used (Japanese Laid-Open Patent Application No. 2014-081620).

### SUMMARY OF THE INVENTION

### Problem to be Solved by the Invention

The present invention aims to provide a developing device including an end portion seal in a new configuration.

### Means for Solving the Problem

In order to solve the above-described problem, the present invention is provided with the following constitution.

(1) A toner carrying device used in an image forming apparatus, comprising: a rotatable member rotatable and constituted so as to carry toner; a frame for rotatably supporting the rotatable member; and a seal member for sealing a gap between an end portion of the rotatable member in a longitudinal direction of the rotatable member and the frame, wherein the seal member includes a surface layer portion contacting the rotatable member, and wherein the surface layer portion contains a fiber yarn to which particles of a solid lubricant are fixed.

(2) An image forming apparatus provided with the toner carrying device described in the above-mentioned (1).

(3) A seal member used for sealing a gap between a rotatable member for carrying toner in an image forming apparatus and a frame for rotatably supporting the rotatable member, the seal member comprising: a surface layer containing a fiber yarn to which particles of a solid lubricant are fixed.

### Effect of the Invention

According to the present invention, it is possible to provide the developing device including the end portion seal in the new configuration.

### BRIEF DESCRIPTION OF THE DRAWINGS

FIG. 1 is a schematic sectional view of an image forming apparatus of an embodiment 1.

FIG. 2 is a sectional view of a process cartridge of the embodiment 1.

FIG. 3 is an exploded perspective view of the process cartridge of the embodiment 1.

FIG. 4 is an exploded view of a part of a developing unit of the embodiment 1.

FIG. 5 is a perspective assembly view of a part of a developing unit of the embodiment 1.

FIG. 6 is an enlarged assembly view of the part of the developing unit of the embodiment 1.

FIG. 7 is a perspective view of an end portion seal of the embodiment 1.

FIG. 8 is an exploded view of a part of a drum unit of the embodiment 1.

FIG. 9 is a perspective assembly view of the part of the drum unit of the embodiment 1.

FIG. 10 is an enlarged assembly view of the part of the drum unit of the embodiment 1.

FIG. 11 is an enlarged view of a surface layer of the end portion seal of the embodiment 1.

FIG. 12 includes schematic enlarged views each of fiber yarns manufactured by a manufacturing method of the embodiment 1.

FIG. 13 is a lubricant application state view of an end portion seal of a modified embodiment of the embodiment 1.

### EMBODIMENTS FOR CARRYING OUT THE INVENTION

In the following embodiments, embodiments in the present invention will be exemplarily described. However, constitutions disclosed in the following embodiments, for example, functions, materials, shapes of component parts and a relative arrangement thereof show examples of configurations relating to claims, and the claims are not intended to limit the claims to the constitutions disclosed in these embodiments. Further, a problem solved by the constitutions disclosed in the following embodiments, or actions and effects obtained from the constitutions are not intended to limit the claims.

Further, an electrophotographic image forming apparatus (image forming apparatus) forms an image on a sheet-like recording medium such as paper by using an electrophotographic image forming process. As an example of the image forming apparatus, a copying machine, a facsimile apparatus, a printer (laser beam printer, LED printer, or the like), and a multi-function machine (multi-function printer), and the like are included. A cartridge is a unit detachably mountable to the above-described image forming apparatus, and is a unit including a photosensitive member and process means (for example, a charging member, a developing member, a cleaning member, and the like) actable on the photosensitive member.

### Embodiment 1

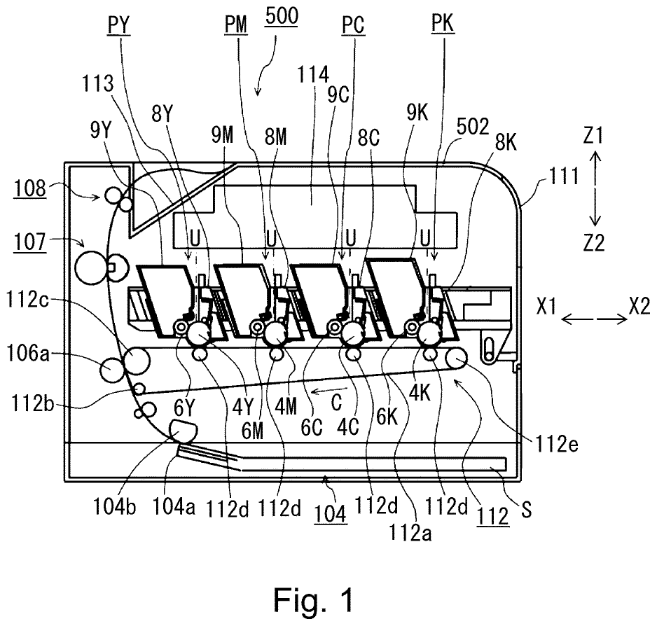

In the following, an embodiment 1 will be described using FIG. 1 to FIG. 13. In the following embodiments, as the image forming apparatus to which four cartridges (hereinafter, referred to as process cartridges) are detachably mountable are exemplified. Incidentally, the number of the process cartridges to be mounted to the image forming apparatus is not limited to this, but may be appropriately set as needed. Further, in the embodiments described below, as a mode of the image forming apparatus, the laser beam printer is exemplified.

### Schematic Constitution of Image Forming Apparatus

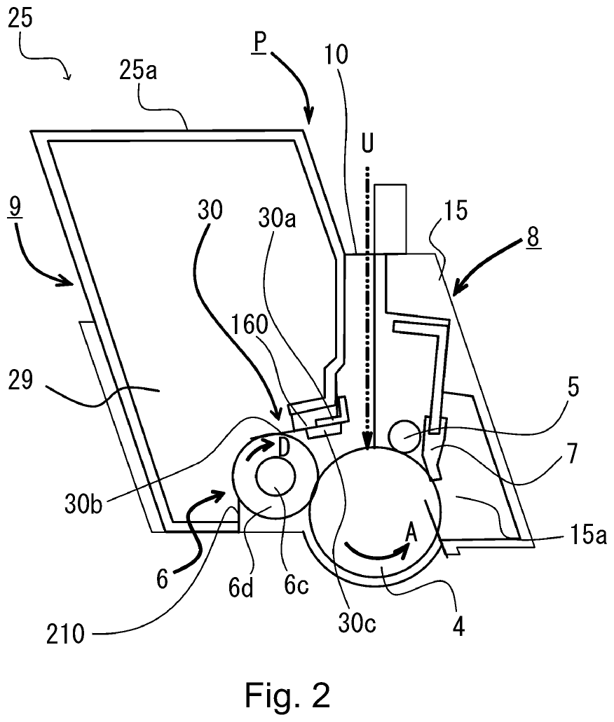

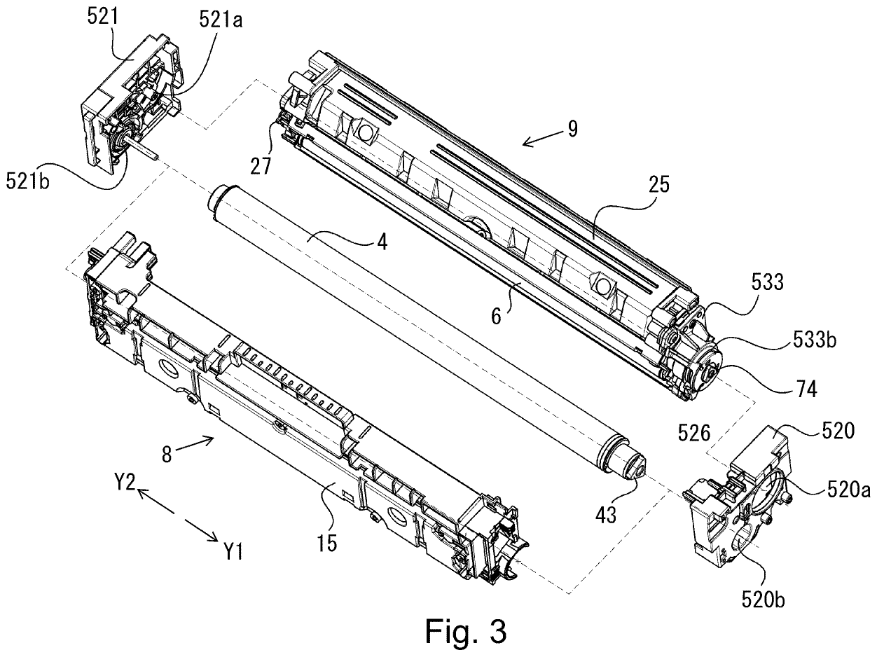

FIG. 1 is a schematic sectional view of an image forming apparatus 500 of the embodiment 1. Further, FIG. 2 is a sectional view of a process cartridge P of the embodiment 1. Further, FIG. 3 is a perspective assembly view of the process cartridge P of the embodiment 1 as viewed from a drive side which is one end side of an axial direction (also a longitudinal direction) of the photosensitive drum (rotatable member) 4.

The image forming apparatus 500 is a four-color(-based) full-color laser printer, and performs color image formation on a recording medium S. The image forming apparatus 500 is of a process cartridge type, and the process cartridge P is made removable from a main body 502 of the image forming apparatus 500, and the process cartridge P is mounted to the main body 502 and a color image is formed on the recording medium S.

Here, as regards the image forming apparatus 500, a side where a front door 111 is provided is referred to as a front surface (frontal surface), and a surface on an opposite side to the front surface is referred to as a rear surface (back surface). Directions thereof are referred to as X2 and X1 directions, respectively (see FIG. 1). Further, a right side when the image forming apparatus 500 is viewed from the front surface is referred to as a drive side, and a left side is referred to as a non-drive side. Directions thereof are referred to as Y1 and Y2 directions, respectively. The longitudinal direction refers to the Y1 and Y2 directions. When the image forming apparatus 500 is viewed from the front side, an upper side is referred to as an upper surface, and a lower side is referred to as a lower surface. Directions thereof are referred to as Z1 and Z2 directions, respectively. FIG. 1 is a sectional view when the image forming apparatus 500 is viewed from the non-drive side.

In the main body 502, four process cartridges P (PY, PM, PC, PK) of a first process cartridge PY, a second process cartridge PM, a third process cartridge PC, and a fourth process cartridge PK are disposed in a substantially horizontal direction. The first to fourth process cartridges P (PY, PM, PC, PK) each having a similar electrophotographic process mechanism, and colors of developers (toner) thereof are different from each other. To the first to fourth process cartridges P (PY, PM, PC, PK), a rotational driving force is transmitted from a drive output portion (not shown) of the main body 502. Further, to the first to fourth process cartridges P (PY, PM, PC, PK), various voltages (charging voltage, developing voltage, and the like) are supplied (not shown) from the main body 502.

As shown in FIG. 2, a frame of each of the first to fourth process cartridges P (PY, PM, PC, PK) of the embodiment 1 rotatably supports the photosensitive drum 4. Each process cartridge P includes a drum unit 8 provided with a charging roller 5 which is a charging means and a cleaning blade 7 which is a cleaning means, which are as process actable on the photosensitive drum 4. Further, each of the first to fourth process cartridges P (PY, PM, PC, PK) shown in FIG. 1 includes a developing unit 9 provided with a developing roller (rotatable member) which is a developing means for developing an electrostatic latent image (for toner image) on the photosensitive drum 4. The drum unit 8 and the developing unit 9 are connected to each other. A more specific constitution of the process cartridge P will be described later.

The first process cartridge PY accommodates toner of yellow (Y) in a developing container 25 as a toner accommodating portion, and forms a toner image of the yellow on a surface of the photosensitive drum 4. The second process cartridge PM accommodates toner of magenta (M) in a developing container 25, and forms a toner image of the magenta on a surface of the photosensitive drum 4. The third process cartridge PC accommodates toner of cyan (C) in a developing container 25, and forms a toner image of the cyan on a surface of the photosensitive drum 4. The process cartridge PK accommodates toner of black (K) in a developing container 25, and forms a toner image of the black on a surface of the photosensitive drum 4.

Above the first to fourth process cartridges P (PY, PM, PC, PK), a laser scanner unit 114 as an exposure means is provided. The laser scanner unit 114 outputs laser light U correspondingly to image information. Then, the laser light U passes through an exposure window 10 of the process cartridge P, and the surface of the photosensitive drum 4 is scanned with and exposed to the laser light U.

Below the first to fourth process cartridges P (PY, PM, PC, PK), an intermediary transfer belt unit 112 as a transfer member is provided. The intermediary transfer belt unit 112 includes a driving roller 112e, a turn roller 112c, and a tension roller 112b, and a transfer belt 112a is extended and stretched around these rollers. Each of the photosensitive drums 4 (4Y, 4M, 4C, 4K) of the first to fourth process cartridges P (PY, PM, PC, PK) contacts an upper surface of the transfer belt 112a at a lower surface thereof. A contact portion thereof is a primary transfer portion. On an inside of the transfer belt 112a, a primary transfer roller 112d is provided opposed to the photosensitive drum 4. To the turn roller 112c, a secondary transfer roller 106a is contacted through the transfer belt 112a. A contact portion between the transfer belt 112a and the secondary transfer roller 106a is a secondary transfer portion.

Below the intermediary transfer belt unit 112, a feeding unit 104 is provided. The feeding unit 104 includes a paper feeding tray 104a on which recording mediums S are stacked and accommodated, and a paper feeding roller 104b. On an upper belt side in the main body 502 in FIG. 1, a fixing device 107 and a discharging device 108 are provided. An upper surface of the main body 502 is a discharge tray 113. On the recording medium S, an unfixed toner image is fixed by the fixing device 107 as a fixing means, and the recording medium S is discharged onto the discharge tray 113.

### Image Forming Operation

An operation for forming a full-color image is as follows. The first to fourth photosensitive drum 4 of each of the process cartridges P (PY, PM, PC, PK) is rotationally driven at a predetermined speed (arrow A direction of FIG. 2). The transfer belt 112a is also rotationally driven at a speed corresponding to the speed of the photosensitive drum 4 in a forward direction (arrow C direction of FIG. 1) relative to rotation of the photosensitive drum 4.

The laser scanner unit 114 is also driven. In synchronism with drive of the laser scanner unit 114, in each process cartridge P, the charging roller 5 electrically charges the surface of the photosensitive drum 4 uniformly to a predetermined polarity and a predetermined potential. The laser scanner unit 114 scans and exposes the surface of each photosensitive drum 4 with and the laser light U depending on an image signal for each (associated) color. By this, an electrostatic latent image depending on an image signal of a corresponding color is formed on the surface of each photosensitive drum 4. The formed electrostatic latent image is developed by the developing roller 6 (6Y, 6M, 6C, 6K) rotationally driven (arrow D direction of FIG. 2) at a predetermined speed.

By an electrophotographic image forming operation as described above, a toner image of yellow corresponding to a yellow component of the full-color image is formed on the photosensitive drum 4 (4Y) of the first process cartridge PY. Then, the toner image is primarily transferred onto the transfer belt 112a. Similarly, a toner image of magenta corresponding to a magenta component of the full-color image is formed on the photosensitive drum 4 (4M) of the second process cartridge PM. Then, the toner image is primarily transferred superposedly onto the toner image of yellow which has already been transferred on the transfer belt 112a. Similarly, a toner image of cyan corresponding to a cyan component of the full-color image is formed on the photosensitive drum 4 (4C) of the third process cartridge PC. Then, the toner image is primarily transferred superposedly onto the toner images of yellow and magenta which have already been transferred on the transfer belt 112a. Similarly, a toner image of black corresponding to a black component of the full-color image is formed on the photosensitive drum 4 (4K) of the fourth process cartridge PK. Then, the toner image is primarily transferred superposedly onto the toner images of yellow, magenta, and cyan which have already been transferred on the transfer belt 112a. Thus, a full-color unfixed toner image is four colors of yellow, magenta, cyan, and black is formed on the transfer belt 112a.

On the other hand, the recording mediums S are separated and fed one by one at a predetermined control timing. The recording medium S is introduced into a secondary transfer portion which is a contact portion between the secondary transfer roller 106a and the transfer belt 112a at a predetermined control timing. By this, in a process in which the recording medium S is conveyed to the secondary transfer portion, superposed toner images of the four colors on the transfer belt 112a are collectively transferred onto a surface of the recording medium S. Thereafter, the toner images are fixed on the surface of the recording medium S by the fixing device 107, and the recording medium S is discharged by the discharging device 108. Incidentally, the image forming apparatus to which the present invention is applied is not limited to the constitution of FIG. 1, but may also be, for example, a constitution provided with a carrying belt for carrying the recording medium S or a monochromatic image forming apparatus. In this case, the recording medium S corresponds to a transfer-receiving member.

### Overall Constitution of Process Cartridge

In the embodiment 1, the first to fourth process cartridges P (PY, PM, PC, PK) include similar electrophotographic process mechanisms and are different from each other in color of toner and filling amount of toner.

The process cartridge P shown in FIG. 2 is provided with the photosensitive drum 4 and the process means actable on the photosensitive drum 4. Here, the process means includes the charging roller 5 as a charging means for charging the photosensitive drum 4 and the developing roller 6 as a developing means for developing a latent image formed by depositing the toner on the photosensitive drum 4. Further, the process means also includes the cleaning blade as a cleaning means for removing residual toner remaining on the surface of the photosensitive drum 4. Further, the process cartridge P is divided into the drum unit 8 and the developing unit 9. Incidentally, a unit or a device (apparatus) may also be referred to as a toner carrying unit or a toner carrying device (apparatus).

### Constitution of Drum Unit

As shown in FIGS. 2 and 3, the drum unit 8 is constituted by the photosensitive drum 4, the charging roller 5, the cleaning blade 7, a cleaning container 15, a residual toner accommodating portion 15a, a drive-side cartridge cover member 520, and a non-drive-side cartridge cover member 521. The photosensitive drum 4 is rotatably supported by the drive-side cartridge cover member 520 and the non-drive-side cartridge cover member 521 which are provided at both (opposite) ends in a longitudinal direction of the process cartridge P. Further, as shown in FIG. 3, on one end side of the photosensitive drum 4 in the longitudinal direction, a coupling member 43 for the photosensitive drum 4 to which a driving force for rotating the photosensitive drum 4 is input is provided. The coupling member 43 engages with a coupling (not shown) as a drive output portion of the main body 502, so that a driving force of a driving motor (not shown) of the main body 502 is transmitted to the photosensitive drum 4. The charging roller 5 is rotatably supported by the cleaning container 15 so as to be capable of being rotated in contact with the photosensitive drum 4. Further, the cleaning blade 7 is supported by the cleaning container 15 so as to contact a peripheral surface of the photosensitive drum 4 at predetermined pressure. Toner (also referred to as transfer residual toner) removed from the peripheral surface of the photosensitive drum 4 by the cleaning blade 7 is accommodated in the residual toner accommodating portion 15a in the cleaning container 15. Incidentally, the drum unit 8 is provided with a residual toner sealing constitution so that the residual toner in the residual toner accommodating portion 15a does not leak out to an outside. Details of the residual toner sealing constitution of the drum unit 8 will be described later.

### Constitution of Developing Unit

As shown in FIGS. 2 and 3, the developing unit 9 is constituted by the developing roller 6, a developing blade 30, the developing container 25, and the like. The developing container 25 includes a toner accommodating portion 29 for accommodating the toner supplied to the developing roller 6, and the developing blade 30 for regulating a layer thickness of the toner on a peripheral surface of the developing roller 6. The developing blade 30 is one formed by mounting an elastic member 30b which is a sheet-like metal of about 0.1 mm in thickness to a supporting member 30a which is a metal material having an L-character cross section. The developing blade 30 is mounted to the developing container 25 by fixing screws 30c at two portions thereof on one end side and the other end side thereof in a longitudinal direction. The developing roller 6 is constituted from a core metal 6c of a metal material and a rubber portion 6d. The developing roller 6 is rotatably supported by a drive-side bearing 526 and a non-drive-side bearing 27 which are mounted to both ends of the developing container 25 in the longitudinal direction.

Further, as shown in FIG. 3, on one end side of the developing unit 9 in the longitudinal direction, a coupling member 74 for the developing roller 6 to which a driving force for rotating the developing roller 6 is input is provided. The coupling member 74 engages with a coupling (not shown) as a drive output portion of the main body 502, so that a driving force of a driving motor (not shown) of the main body 502 is input to the developing unit 9. The driving force input to the developing unit 9 is transmitted by an unshown driving train provided in the developing unit 9, so that the developing roller 6 is capable of being rotated in an arrow D direction of FIG. 2. On one end side of the developing unit 9 in the longitudinal direction, a development cover member 533 for supporting and covering the coupling member 74 and an unshown driving train is provided. Incidentally, to the developing unit 9, toner sealing constitution (160, 210, and the like described later) is provided so that the toner in the toner accommodating portion 29 does not leak out to the outside. Details of the toner sealing constitution will be described later.

### Assembling of Drum Unit and Developing Unit

Using FIG. 3, assembling of the drum unit 8 and the developing unit 9 will be described. The drum unit 8 and the developing unit 9 are held by the drive-side cartridge cover member 520 and the non-drive-side cartridge cover member 521 which are provided at both ends of the process cartridge P in the longitudinal direction. The drive-side cartridge cover member 520 provided on one end side of the process cartridge P in the longitudinal direction is provided with a supporting hole 520a. Further, the non-drive-side cartridge cover member 521 provided on the other end side of the process cartridge P in the longitudinal direction is provided with a cylindrical supporting portion 521a. Further, the drive-side cartridge cover member 520 and the non-drive-side cartridge cover member 521 are provided with supporting hole portions 520b and 521b, respectively, for rotatably supporting the photosensitive drum 4.

Here, on one end side, in the supporting hole 520a of the drive-side cartridge cover member 520, an outer diameter portion of a cylindrical portion 533b of the development cover member 533 is engaged. On the other end side, the supporting portion 521a of the non-drive-side cartridge cover member 521 is engaged in a hole of the non-drive-side bearing 27. Further, both ends of the photosensitive drum 4 in the longitudinal direction are engaged in the supporting hole portion 520b of the drive-side cartridge cover member 520 and the supporting hole portion 521b of the non-drive-side cartridge cover member 521, respectively. Then, the drive-side cartridge cover member 520 and the non-drive-side cartridge cover member 521 are fixed to the cleaning container 15 by unshown screws or by bonding or the like.

Accordingly, the drive-side cartridge cover member 520 and the non-drive-side cartridge cover member 521 are integrated with the cleaning container 15 and constitute the drum unit 8. Further, the developing unit 9 is swingably (movably) supported relative to the drum unit 8 (the photosensitive drum 4) by the drive-side cartridge cover member 520 and the non-drive-side cartridge cover member 521, and thus is integrally assembled as the process cartridge P.

### Toner Sealing Constitution of Developing Unit

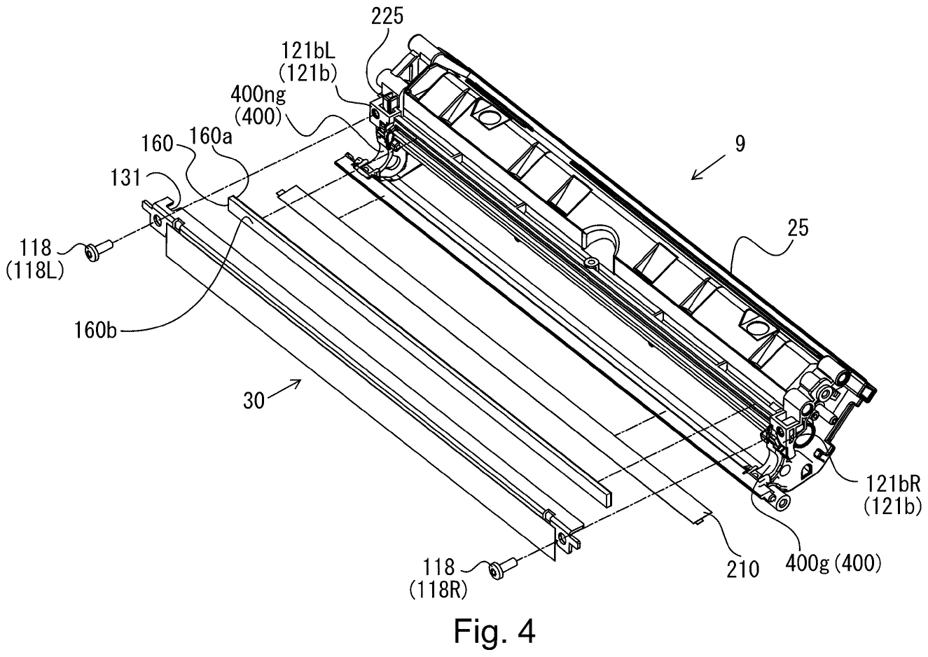

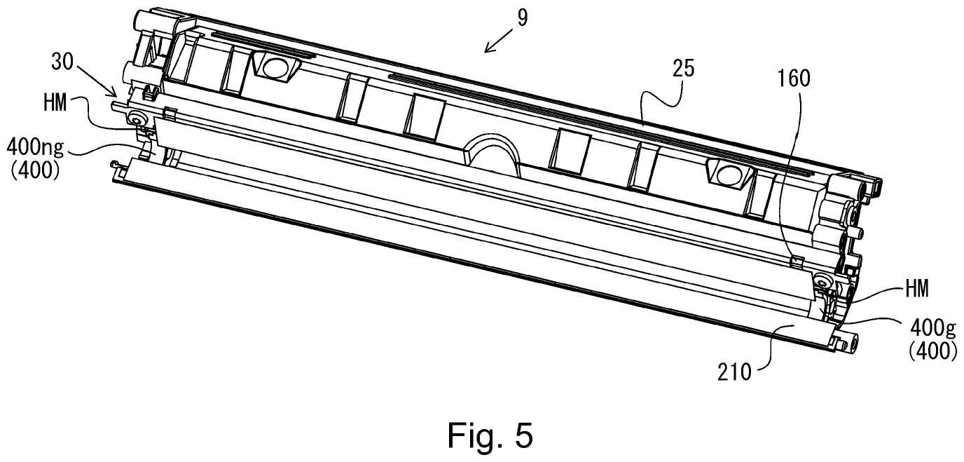

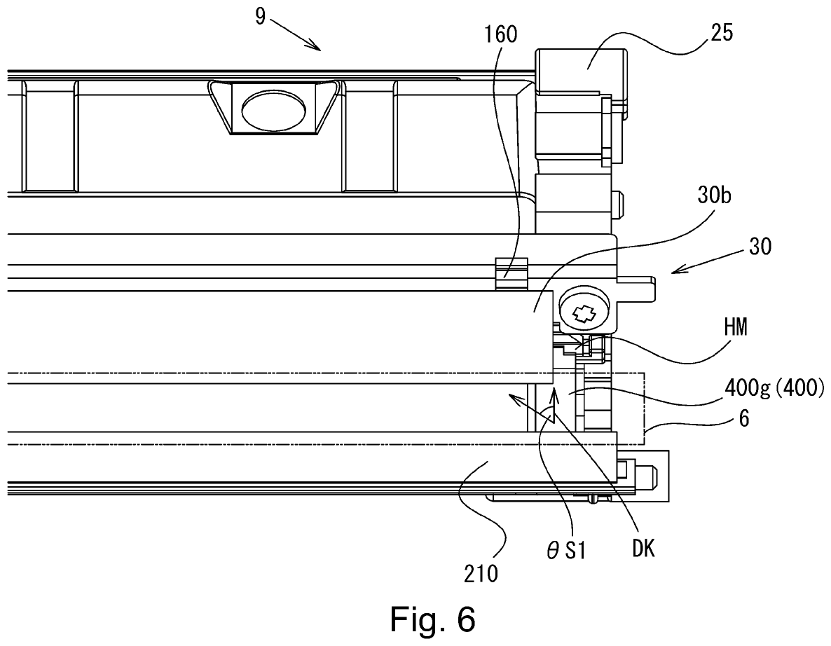

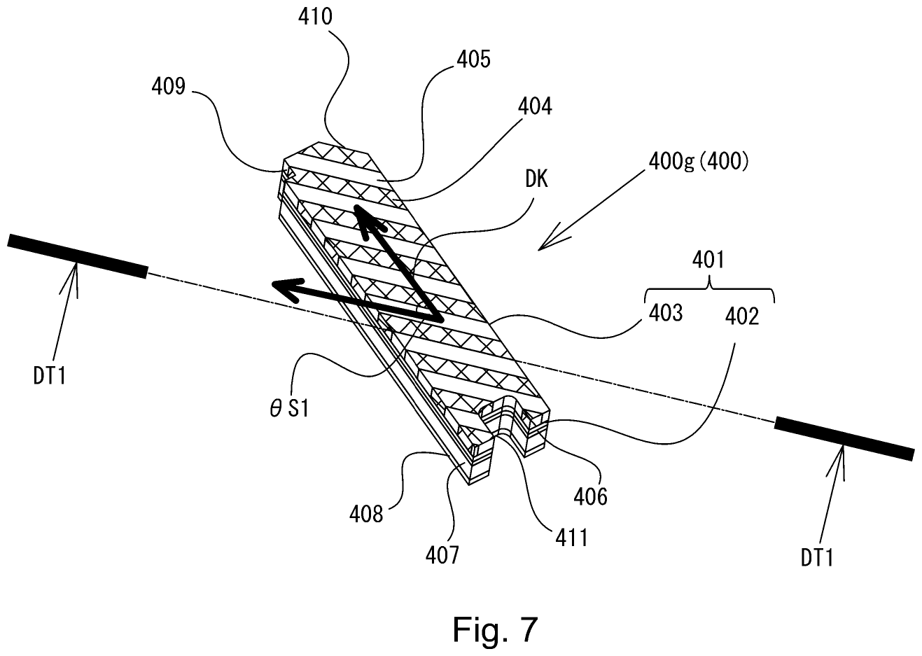

Next, a toner sealing constitution of the developing unit 9 will be described using FIG. 4 to FIG. 7. FIG. 4 is an exploded perspective view of the developing unit 9 as viewed from the drive side when the developing blade 30, a lower seal 160 of the developing blade 30, and a development-side sheet member 210 are assembled to the developing container 25. FIG. 5 is an assembling perspective view of the developing unit 9 as viewed from the drive side after the developing blade 30, the lower seal 160 of the developing blade 30, and the development-side sheet member 210 are assembled to the developing container 25. FIG. 6 is an enlarged assembly view of a part of the developing unit 9 on the drive side as viewed from the front surface (side) after the developing blade 30, the lower seal 160 of the developing blade 30, and the development-side sheet member 210 are assembled to the developing container 25. FIG. 7 is a perspective view of a drive end portion seal 400g on the development side.

As shown in FIG. 4 to FIG. 6, as the toner sealing constitution for sealing the toner in the developing container 25, an end portion seal 400 as a development-side sealing member, the lower seal 160 of the developing blade 30, and the development-side sheet member 210 are disposed to the developing container 25. The end portion seal 400 on the development side includes a drive end portion seal 400g and a non-drive end portion seal 400ng. The end portion seal 400 seals a gap between the developing roller 6 and the developing container 25 in an end portion of the developing roller 6 in the longitudinal direction.

The end portion seal 400 on the development side is disposed in the developing container 25 in a manner such that the end portion seal 400 is curved so as to hermetically contact the peripheral surface of the developing roller 6. FIG. 7 is a perspective view of the drive end portion seal 400g on the development side. The drive end portion seal 400g on the development side is constituted by a fiber surface layer 401, an intermediate adhesive layer 406, an intermediate layer 407, and a container adhesive layer 408. During drive of the developing roller 6, the fiber surface layer 401 of the end portion seal 400 on the development side where the end portion seal 400 contacts the developing roller 6 becomes a state in which the fiber surface layer 401 is rubbed by the developing roller 6. Further, on the developing container 25 side of the development-side end portion seal 400, the container adhesive layer is present, and is adhesively fixed to the developing container 25. Details of the end portion seal 400 on the development side will be described later.

Further, as shown in FIG. 4 to FIG. 6, on the rubbing surface side of the development-side end portion seal 400 with the developing roller 6, on an upstream side of the rotational direction (DK direction) of the developing roller 6, a flexible development-side sheet member 210 is disposed. On the other hand, on a downstream side of the rotational direction (DK direction) of the developing roller 6, the elastic member 30b of the developing blade 30 is disposed.

The developing blade 30 is constituted by the supporting member 30a and the elastic member 30b. The elastic member 30b comprises a stainless steel plate or an about 0.1 mm-thick thin plate of phosphor bronze. Further, the supporting member 30a comprises a steel plate of 1-2 mm in thickness. The supporting member 30a and the elastic member 30b are positioned by an unshown positioning mechanism, and are bonded by spot welding or the like by a laser. Further, to the supporting member 30a, a first cut-away portion 131 for being positioned to the developing container 25 is disposed, and is engaged with a positioning portion 225 of the developing container 25, so that the first cut-away portion 131 determines a position of the process cartridge P with respect to the longitudinal direction. Further, the supporting member 30a is fixed by screws 118 (118R, 118L) in a state in which the supporting member 30a is abutted against blade mounting surfaces 121b (121bR, 121bL) of the developing container 25. Incidentally, of a widthwise direction of the elastic member 30b, an opposite side from a side where the elastic member 30b is bonded to the supporting member 30a becomes a free end, and a part of this free end contacts the peripheral surface of the developing roller 6, so that an amount of the toner held by the developing roller 6 is regulated.

Here, a constitution in which the development-side sheet member 210 is nipped by the development-side end portion seal 400 and the developing roller 6 is employed. By this, a range in which the development-side sheet member 210 and the development-side end portion seal 400 contact each other, a range in which the development-side end portion seal 400 and the developing roller 6 contact each other, and a range in which the developing roller 6 and the development-side sheet member 210 contact each other are present.

Further, the elastic member 30b of the developing blade 30 is nipped by the development-side end portion seal 400 and the developing roller 6, so that the elastic member 30b and the development-side end portion seal 400, the development-side end portion seal 400 and the developing roller 6, and the developing roller 6 and the elastic member 30b are contacted to each other, respectively. By this, gaps of the end portion in the developing container 25 in the longitudinal direction are closed, so that toner sealing on the development-side end portion seal 400 is performed.

The lower seal 160 of the developing blade 30 includes a double-side tape 160a and an elastic foam member 160b of the lower seal 160, and is mounted to the developing container 25 by the double-side tape 160a. The lower seal 160 is constituted so that a gap between the supporting member 30a and the developing container 25 is closed when thereafter the developing blade 30 is assembled to the developing container 25.

Here, as shown in FIG. 6, a constitution in which a hot-melt resin HM is injected in a minute gap when the end portion seal 400, the developing blade 30, and the lower seal 160 of the developing blade 30 are mounted to the developing container 25, whereby adhesiveness thereof is ensured is employed. The non-drive side has a similar constitution, and therefore, description will be made for the drive side. As shown in FIG. 7, the hot-melt adhesive HM is injected in cut-away portions 409 and 410 for hot-melt adhesion of the development-side end portion seal 400g. By this, it is possible to hermetically seal the minute gaps when the development-side end portion seal 400g mounted to the developing container 25, the developing blade 30, and the lower seal 160 are mounted. Incidentally, the hot-melt adhesive HM in the embodiment 1 comprises a mixture of thermoplastic rubber, adhesiveness-imparting resin, and the like, and has a feature such that the mixture is liquefied by heating and is hardened into an elastic solid by cooling.

The development-side sheet member 210 is an about 0.1 mm-thick flexible resin sheet comprising resin such as PPS, and is stuck and fixed to the developing container 25 by a double-side tape stuck to a developing frame 25a. The development-side sheet member 210 is disposed on a side downstream of the developing blade 30 in the rotational direction of the developing roller 6 and over a whole area in the longitudinal direction of the developing container 25. Of a widthwise direction of the development-side sheet member 210, a side toward the developing roller 6 becomes a free end, and is constituted so that a part of the free end contacts a peripheral surface of the developing roller 6 in a whole area in the longitudinal direction of the developing roller 6. Further, an end portion of the development-side sheet member 210 in the longitudinal direction is constituted so that at least a part thereof contacts and overlaps with the fiber surface layer 401 of the above-described development-side end portion seal 400.

Here, as shown in FIG. 6, a constitution is provided so as to ensure adhesiveness of the hot-melt resin HM by injecting the hot-melt resin HM into a minute gap when the development-side end portion seal 400 and the development-side sheet member 210 are mounted to the developing container 25. Further, as shown in FIG. 7, by injecting the hot-melt resin HM into the cut-away portion 411 of the development-side drive end portion seal 400g, it is possible to hermetically seal the minute gap the end portion seal 400 and the sheet member 210 which are mounted to the developing container 25.

As described above, after the end portion seal 400, the developing blade 30, the lower seal 160, and the hot-melt resin HM are mounted to the developing container 25, the developing roller 6 is assembled to the developing container 25, so that a state of the developing unit 9 is formed. By this, sealing is made without causing leaking-out of the toner from the toner accommodating portion 29 in the developing container 25 to the outside of the developing unit 9.

### Toner Sealing Constitution of Drum Unit

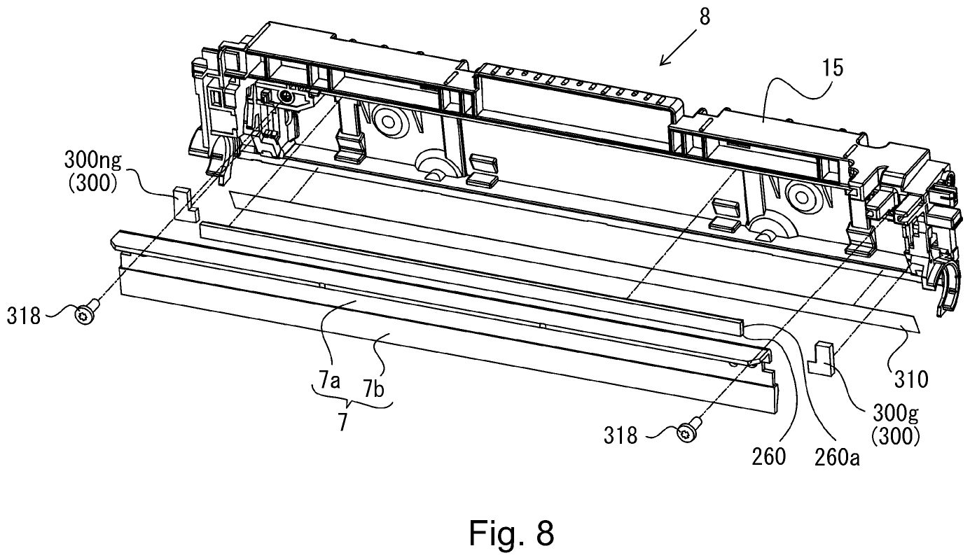

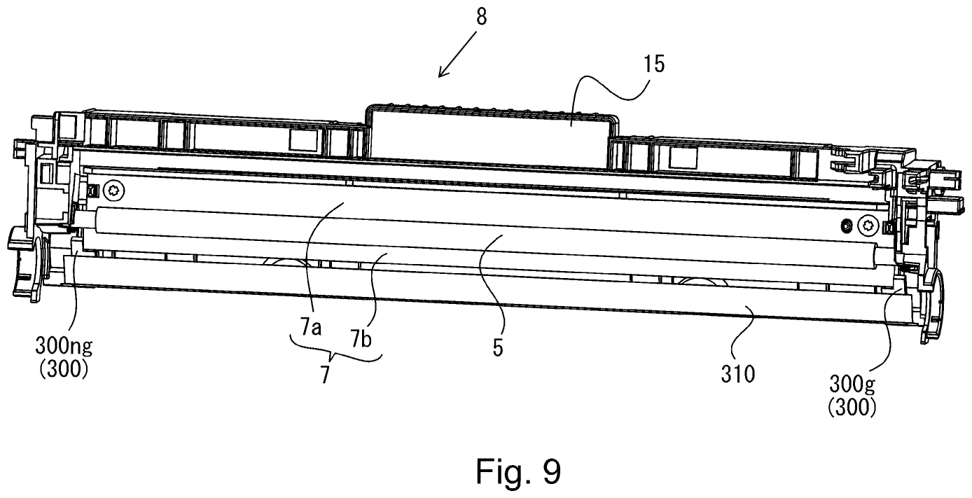

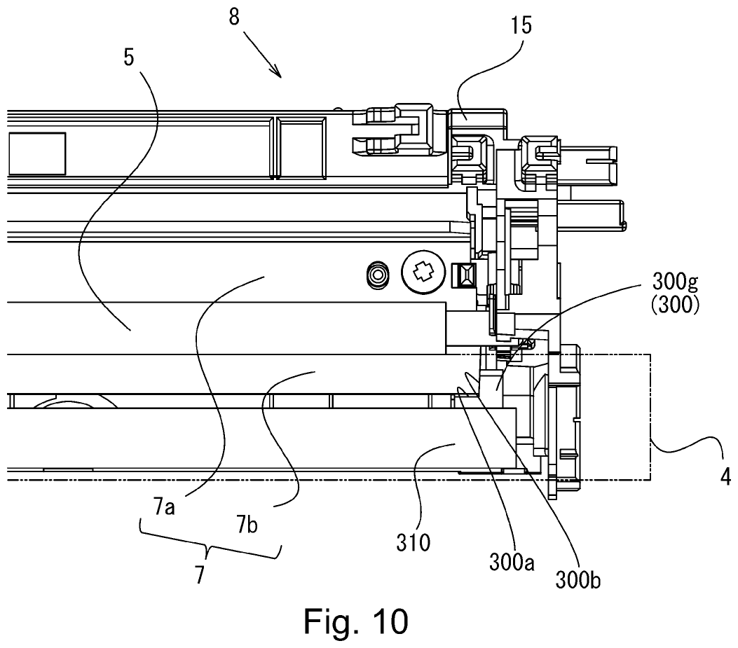

FIG. 8 is a state view before a cleaning-side sheet member 310, the cleaning blade 7, and the charging roller 5 are assembled to the cleaning container 15. FIG. 9 is an enlarged assembly view of a part of the drum unit 8 in a state in which the photosensitive drum 4 is removed from the drum unit 8. FIG. 10 is an enlarged view of a drive side of FIG. 9.

As shown in FIG. 2 and FIG. 8 to FIG. 10, a constitution for sealing the toner in the residual toner accommodating portion 15a in the cleaning container 15 is as follows. In the cleaning container 15, the cleaning blade 7, a cleaning-side end portion seal 300, a lower seal 260 of the cleaning blade 7, and the cleaning-side sheet member 310 are disposed. Incidentally, the cleaning-side end portion seal 300 specifically includes a drive end portion seal 300g and a non-drive end portion seal 300ng. The end portion seal 300 seals a gap between the photosensitive drum 4 and the residual toner accommodating portion 15a in each of end portions with respect to the longitudinal direction of the photosensitive drum 4. Details of a cleaning-side end portion seal 300 will be described later.

Further, on a rubbing surface side between the cleaning-side end portion seal 300 and the photosensitive drum 4, on an upstream side in the rotational direction of the photosensitive drum 4, a flexible sheet member 310 is disposed. On the other hand, on a downstream side in the rotational direction of the photosensitive drum 4, an elastic member 7b of the cleaning blade 7 is disposed.

Here, a constitution in which the sheet member 310 contacting the photosensitive drum 4 is sandwiched by the cleaning-side end portion seal 300 and a part of the photosensitive drum 4 is provided. A range in which the cleaning-side sheet member 310 and the cleaning-side end portion seal 300 are contacted to each other and a range in which the photosensitive drum 4 and the cleaning-side sheet member 310 are contacted to each other are present.

The cleaning blade 7 is constituted by a supporting portion 7a fixed to the cleaning container 15 and the elastic member 7b for cleaning transfer residual toner which is not completely transferred by rubbing in contact with the photosensitive drum 4. The supporting member 7a is an iron plate of about 1 mm in thickness, and is fixed to the cleaning container 15 with screws 318. The elastic member 7b is formed by a rubber or the like of about 1 mm in thickness, and is contacted to the photosensitive drum 4.

Further, the end portion seal 300 has an L-character shape as more specifically shown in FIG. 10. In an end portion of the cleaning blade 7 in a longitudinal direction of the elastic member 7b, a parallel end surface 300a and a perpendicular end surface 300b which are an L-character shape portion of the end portion seal 300 are disposed so as to contact an end portion L-character shape portion (corner) of the elastic member 7b of the cleaning blade 7. By this, a gap of an end portion of the cleaning container 15 in a longitudinal direction is closed, so that toner sealing of an end portion of the elastic member 7b of the cleaning blade 7 in a longitudinal direction is performed.

The lower seal 260 of the cleaning blade 7 comprises an elastic foam member such as urethane foam, and is stuck to the cleaning container 15 by a double-side tape 260a of the lower seal 260. Thereafter, a constitution in which a gap between the cleaning blade 7 and the cleaning container 15 in the longitudinal direction is closed when the cleaning blade 7 is mounted to the cleaning container 15 is provided. A material of the lower seal 260 may only be required to be capable of closing the gap, and therefore, a constitution in which the gap is closed by a hot-melt material, an elastomer material, silicon bond application, or the like may also be provided.

The end portion seal 300 includes a layer comprising an elastic foam member such as urethane foam, and is stuck to the cleaning container 15. Thereafter, a constitution in which ha gap between the cleaning blade 130 and the cleaning container 121 in a longitudinal direction is closed when the cleaning blade 7 is mounted to the cleaning container 15 is provided. The end portion seal 300 may only be required so as to be capable of closing the gap, and may also have a constitution in which the gap is closed similarly as the end portion seal 400 by the hot-melt material, the elastomer material, the silicon bond application, or the like.

The cleaning-side sheet member 310 is an about 0.1 mm-thick flexible resin sheet comprising resin such as PPS, and is stuck and fixed to the cleaning container 15 by a double-side tape stuck to the cleaning container 15. The cleaning-side sheet member 310 is disposed on a side upstream of the cleaning blade 7 in the rotational direction of the photosensitive drum 4 and over a whole area of the cleaning container 15 with respect to the longitudinal direction. Of a widthwise direction of the cleaning-side sheet member 310, a side toward the photosensitive drum 4 becomes a free end, and a part of the free end is constituted so as to contact the peripheral surface of the photosensitive drum 4 in a whole area in the longitudinal direction. Further, an end portion of the cleaning-side sheet member 310 in the longitudinal direction is constituted so that at least a part thereof contacts and overlaps with the fiber surface layer 401 of the end portion seal 300.

As described above, after the end portion seal 300, the cleaning blade 7, and the lower seal 260 are mounted to the cleaning container 15, the charging roller 5 and the photosensitive drum 4 are assembled to the cleaning container 15, and in addition, a side cover is mounted to the cleaning container 15, so that a state of the drum unit 8 is formed. By this, sealing is performed without causing leaking-out of the residual toner from the residual toner accommodating portion 15a in the cleaning container 15 to the outside of the drum unit 8.

### Detailed Constitution of the Toner Seal (End Portion Seal)

FIG. 7 is a perspective view of the development-side drive end portion seal 400g in the developing unit 9. The development-side non-drive end portion seal 400ng also has a similar constitution, and therefore, the drive end portion seal 400g will be described. Further, the cleaning-side end portion seals 300 (drive end portion seal 300g, non-drive end portion seal 300ng) are different in shape, but have similar constitutions, and therefore, the drive end portion seal 400g will be described. The drive end portion seal 400g is constituted by the fiber surface layer 401, the intermediate adhesive layer 406, the intermediate layer 407, and the container adhesive layer 408.

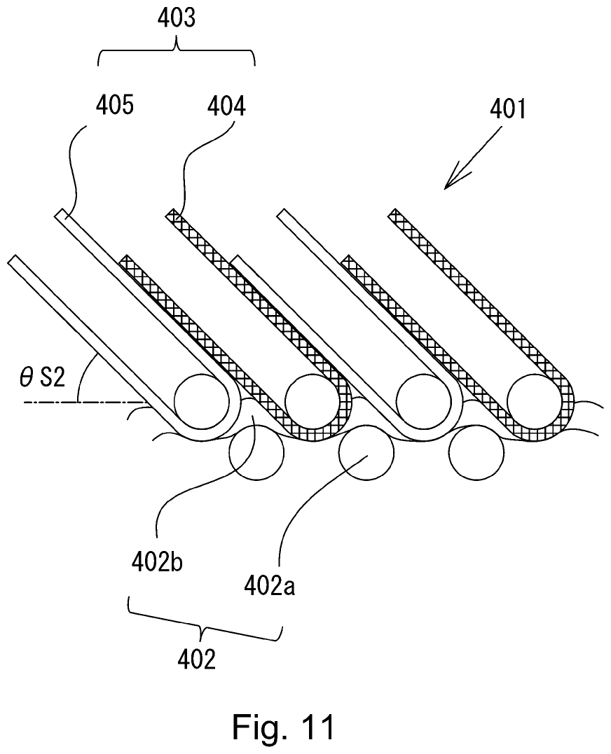

FIG. 11 is a DT1 sectional view of FIG. 7, and is an enlarged view of the fiber surface layer 401 as a first layer is constituted by a base cloth portion (base material) 402 constituted by weaving warp yarns 402a and welt yarns 402b substantially perpendicular to each other and a fiber portion 403 as a fiber portion (surface layer) woven by pile weave so as to be raised on the base cloth portion 402. When the fiber surface layer 401 contacts the developing roller 6 or the photosensitive drum 4, by rotation of the developing roller 6 or the photosensitive drum 4, the fiber portion 403 is rubbed. Hereinafter, an example of contact with the developing roller 6 will be described.

Here, the fiber portion 403 is a pile fabric which is constituted by a plurality of fiber yarns of materials different in kind and which is obtained by being woven so that the different fiber yarns are disposed in a stripe shape when a surface layer surface thereof is viewed from an opposite side to the developing roller 6. Here, a pile fiber portion including lubricant containing fiber yarns 404 in which a lubricant is contained in the fiber yarns and lubricant non-containing fiber yarns 405 in which the lubricant is not contained in the fiber yarns is disposed in a stripe shape in a certain interval. Incidentally, the lubricant containing fiber yarns 404 may only be required to be used as at least a part of the fiber surface layer 401, and the interval of the stripe shape and a ratio between the lubricant containing fiber yarn 404 and the lubricant non-containing fiber yarns 405 are not required to be 1:1. Further, the end portion seals 300 and 400 may only be required to include at least one kind of fiber yarn containing the lubricant, and may include a plurality of kinds of fiber yarns containing the lubricant.

The lubricant used in the embodiment 1 is a kind as a lubricant used for purposes for suppressing a temperature rise due to sliding friction and for suppressing abrasion of the fiber surface layer 401 due to the sliding friction, by lowering the sliding friction. For a fiber material of the lubricant containing fiber yarns (first fiber yarn) 404, for example, a material such as polyester, nylon, acrylic, rayon, or polyolefin is used. Incidentally, the material is not limited to these. For a fiber material of the lubricant non-containing fiber yarns (second fiber yarn) 405, materials similar to those of the lubricant containing fiber yarns 404, and a fluorine-based material such as PTFE (polytetrafluoroethylene), PFA (perfluoroalkoxyalkane), or ETFE (ethylene-tetrafluoroethylene) are used. Incidentally, the material is not limited to these.

Here, as a purpose for using the plurality of fiber yarns including the lubricant containing fiber yarns 404 and the lubricant non-containing fiber yarns 405, the fiber yarns are selectively used depending on different functions and costs. There are various advantages and disadvantages in general for the respective fibers. For example, fiber yarns high in slidability and temperature rise suppressing performance are fiber yarns which do not reach functions required to terms of fiber strength, a charging characteristic, a manufacturing cost, and the like, in some cases. In order to compensate for that point, it is possible to select the fiber yarns depending on the function, the cost, and the like by constituting the fiber yarns with fiber yarns of two kinds or more including the lubricant containing fiber yarns 404 and the lubricant non-containing fiber yarns 405 as in the embodiment 1.

In the embodiment 1, by using the lubricant containing fiber yarns 404 as at least a part of the fiber surface layer 401, compared with only by the lubricant non-containing fiber yarns 405, fiber yarns inexpensive in manufacturing cost can used in the end portion seal while compensating for the slidability and the temperature rise suppressing performance. For the lubricant non-containing fiber yarns 405, the fiber material may only be required to be selected selectively. Further, the fiber yarns may also be constituted only by the lubricant containing fiber yarns 404 without using the lubricant non-containing fiber yarns 405.

Further, as shown in FIG. 11, here, the fiber yarns are tilted by an angle θS2 by being heated in advance so that the lubricant containing fiber yarns 404 and the lubricant non-containing fiber yarns 405 are tilted in advance. Here, a state in which the fiber yarns are not tilted is taken as 0°, and a setting is made so that the fiber yarns are tilted by 10° to 90°. By that, even when the developing roller 6 is rotated, directions of the respective fibers can be regulated, so that stable contact becomes possible. Incidentally, tilting (falling) of the fiber yarns particularly need not to be tilted.

Further, as shown in FIG. 7, the lubricant containing fiber yarns 404 and the lubricant non-containing fiber yarns 405 are disposed in a stripe shape with respect to the longitudinal direction of the end portion seal 400, i.e., the rotational direction (DK direction) of the developing roller 6. By this, the developing roller 6 alternately rubs the lubricant containing fiber yarns 404 and the lubricant non-containing fiber yarns 405 when being rotated. As regards a stripe-shaped arrangement, the stripe shape depend on a diameter of the rotatable member, a length of the fiber portion 403, and whether or not the respective fibers are contacted at what ratio, and therefore, the angle θS2 may only be required to be set in view of the toner sealing property, manufacturing cost, and the like.

Further, as shown in FIG. 7, the respective fiber yarns in the fiber portion 403 are constituted in a state in which the fiber yarns are tilted toward an inside of the developing container 25 by an angle θS1 with respect to the rotational direction (DK) of the developing roller 6. This is to deal with the case where the toner carried on the developing roller 6 partially enters the fiber surface layer 401 when a rotation time is increased by repeating the image formation. In addition, this is also to deal with the case where the toner scattered by the influence of air flow by an air fan installed in the image forming apparatus is deposited on the surface of the fiber surface layer 401. The fiber yarns are disposed with the angle θS1 so that the toner is readily returned to the inside of each container by a rotating frictional force of the developing roller 6. Here, the angle θS1 is set with a tolerance 30° to 60° centered at the angle θS1=45° toward the longitudinal direction of the inside of each container. Incidentally, the angle θS1 may also only be required to be set in view of the toner sealing property, the manufacturing cost, and the like. Incidentally, the angle is not needed to be provided by satisfying (angle θS1)=(rotational direction of developing roller 6).

Further, as shown in FIG. 11, the length of the fiber yarns used in the fiber portion 403 is set to a length such that the developing roller 6 and the base cloth portion 402 do not contact each other when the fiber surface layer 401 contacts the developing roller 6. Here, performances of the fiber portion 403 and the base cloth portion 402 are used selectively and properly, and therefore, the developing roller 6 is prevented from contacting the base cloth portion 402. When the raised fiber portion 403 contacts the developing roller 6, the fiber portion 403 contacts the developing roller 6 so that the fiber portion 403 is fallen and folded on the developing roller 6, and therefore, the developing roller 6 and the base cloth portion 402 do not contact each other. The base cloth portion 402 is required to have a fiber diameter for weaving the fiber yarns at a density such that the toner does not readily enter the vicinity of a base portion of the fiber portion 403. Further, the base cloth portion 402 is also required to have durability, flexibility, heat resistance, and the like so that the fiber portion 403 does not come off by a sliding resistance force between the fiber portion 403 and the developing roller 6. The base cloth portion 402 does not contact the developing roller 6, and therefore in order to reduce cost, it is also possible to use, for example, inexpensive fiber yarns having no sliding performance. Incidentally, the fibers used in the fiber surface layer 401 may also be used.

In order that the fiber portion 403 does not come off from the base cloth portion 402, the following is performed. Here, the base portion of the fiber portion 403 and the base cloth portion 402 are fixed by a method such that hot melt, a curable coating gent made of synthetic resin, a thermoplastic resin sheet, thermoplastic fibers, and the like are subjected to infiltration, coating (application), heat melting, or the like. Incidentally, a fixing method is not limited to this method.

Thus, the fiber yarns are constituted so as to be used properly between the fiber portion 403 contacting the developing roller 6 and the base cloth portion 402 not contacting the developing roller 6, so that the cost of the fibers used in the base cloth portion 402 is reduced, and thus it becomes possible to realize a low-cost end portion seal 400. It becomes possible to provide a surface layer constitution for the purpose of improving the toner sealing performance by changing density and a weaving manner of the fiber portion 403. These are appropriately changed in accordance with a target lifetime of the process cartridge P.

The fiber surface layer 401 of the end portion seal 400 uses a fiber surface layer 401 of pile weave by the fiber portion 403 in a state in which the fiber yarns are raised, in consideration of adhesiveness with the developing roller 6, a constitution in which the fiber yarns are tilted toward the inside of the developing container 25, a toner collecting property, a heat dissipation property, and the like. However, the fiber surface layer 401 may only be required to use the fiber yarns, and may also have, for example, in addition to the pile weave, a constitution in which sealing is performed only by the warp yarns and the weft yarns of the base cloth portion 402, a constitution by knitting for knitting the fiber yarns, a constitution in which the fiber yarns are interwound as in a nonwoven fabric, and a constitution in which the fiber yarns are crimped. At that time, the lubricant containing fiber yarns 404 is provided to at least a part of the fiber surface layer 401, so that it is possible to obtain the above-described lubricant containing effect. A constitution in which the lubricant containing fiber yarns 404 are contained in the base cloth portion 402 itself may also be provided. This is also similarly applicable to either case of the pile weave, the knitting, and the nonwoven fabric. Incidentally, in this case, the fiber portion (surface layer) 403 may also be constituted by raising the fibers from the base cloth portion 402 through raising processing of the surface. Incidentally, electrostatic flocking (processing) such that an adhesive is applied to the base cloth portion 402 by a spray gun or the like and lubricant containing fiber yarns are planted on a base material by utilizing an electrostatic force under application of a high voltage of 30,000 V to 80,000 V may also be used.

The intermediate layer 407 as a second layer is an elastic layer comprising an elastic member for bringing the fiber surface layer 401 into contact with the developing roller 6 at a predetermined pressure. For example, foamed polyurethane is used. Further, the intermediate layer 407 has a thickness in which a gap between the developing frame 25a and the developing roller 6 can be sufficiently closed even when the gap is fluctuated by a dimensional tolerance or an erection tolerance of each component part. Here, a foam member of synthetic resin obtained by adding carbon black into the foamed polyurethane is used. For example, in addition to this, polystyrene, polypropylene, or a rubber material such as elastomer or a natural rubber, or the like may also be used. Incidentally, in the case where the electrostatic flocking is used, the lubricant containing fiber yarns 404 may also be directly planted into the intermediate layer 407 (base material).

The intermediate adhesive layer 406 as a third layer is an adhesive layer by which the base cloth portion 402 and the intermediate layer 407 are fixed by bonding, for example. The intermediate adhesive layer 406 may only be required to be capable of fixing the base cloth portion 402 and the intermediate layer 407 without impairing a sealing performance of the base cloth portion 402 and a repelling force performance of the intermediate layer 407. Here, the fixing is performed by a double-side tape, hot melt, a curable coating agent made of synthetic resin, a thermoplastic resin sheet, thermoplastic fibers, and the like. Incidentally, a fixing method is not limited thereto.

The container adhesive layer 408 as a fourth layer is an adhesive layer for fixing the end portion seal 400 to the developing container 25 which is an assembly object. Incidentally, in the case of the end portion seal 300, the container adhesive layer 408 becomes a layer for fixing the end portion seal 300 to the residual toner accommodating portion 15a. Here, the container adhesive layer 408 may only be required to be fixed to the developing container 25 without impairing the repelling force performance of the intermediate layer 407, and is fixed by the double-side tape or the hot melt. Incidentally, the fixing method is not limited thereto.

### Detailed Constitution of Lubricant and Lubricant Containing Fiber Yarns

The toner is deposited on the end portion seal in some cases by the influences of the rotations of the developing roller 6 and the photosensitive drum 4, air flow of the main body fan, and the like when the image is formed as described above. For this reason, the end portion seal is required to improve various performances as various influences on the toner sealing performance. For example, further improvements in toner wiping performance, toner collecting performance toward the inside of the fiber portion, sliding performance for improving toner flowability for returning the toner in a container inside direction, temperature rise suppressing performance for preventing toner fusion to frictional heat, heat dissipation performance, and the like.

In the embodiment 1, for the purpose of incorporating the lubricant in the fiber yarns of the end portion seals 300 and 400, improvements in sliding performance and temperature rise suppressing performance which relative to the toner sealing performance are directed.

Further, as one of improving methods of the sliding performance, the temperature rise suppressing performance, the heat dissipation performance, and the like of a seal surface of the end portion seal, there is a method in which a particulate material is applied to the seal surface, but the particulate material is not directly fixed to the fibers. For that reason, there is a liability that the particulate material gradually comes off from the seal surface or is scattered due to an increase in speed and lifetime extension of the process cartridge. For that reason, by using lubricant containing fibers, the lubricant is in a state in which the lubricant is fixed to the fibers, and therefore, functionality of the seal surface becomes easier to be kept than in a particulate material application method. Incidentally, application of the particulate material to the seal surface may also be used in combination with the above-described method.

As the lubricant used in the present invention, a liquid lubricant and a solid lubricant are present. As the liquid lubricant, a hydrocarbon-based liquid, a silicone-based liquid, and the line are cited. Further, as the solid lubricant, molybdenum sulfide, tungsten disulfide, graphite, graphite fluoride, hexagonal boron nitride (h-BN), organic fluorine compounds (PTFE, PVDF, etc.), melamine cyanurate, dimethyl silicone oil, and the like.

As the lubricant contained in the fiber yarns of the end portion seals 300 and 400 in the present invention, the solid lubricant is preferred. The toner used in electrophotography is fine particles, and in addition, is constituted by a resin component having a relatively low molecular weight, so that there is a liability that toner particles are agglomerated when the liquid lubricant is used and cause a defect. Further, there is also a liability that some of the liquid lubricant attacks the toner and causes a phenomenon such as blocking of the toner. On the other hand, in the solid lubricant particles used in the present invention, generation of toner agglomerate and the occurrence of the phenomenon such as the blocking of the toner, which are cited above are reduced. For that reason, the solid lubricant is preferably used.

Of these, in the present invention, the hexagonal boron nitride (boron nitride) is particularly preferred as the solid lubricant. The hexagonal boron nitride is insulative, and in the case of being used for the electrophotography, the occurrence of the phenomenon as described above is reduced. Further, the hexagonal boron nitride is also high in thermal conductivity, so that an effect of dissipation of heat (heat dissipation performance) generated in the case of being used in a sliding portion such as the end portion seals 300 and 400 is also expected.

Further, a particle diameter of the solid lubricant is preferred to be 50 μm or less, further 30 μm or less, and further 10 μm or less, in terms of an average primary particle diameter. As a diameter of filaments (fibers) used as the fiber yarns of the surface layers of the end portion seals 300 and 400, the diameter is 50 μm or less in many instances. In the case where divided fibers or the like are used, the diameter is 10 μm or less is many instances. For that reason, the particle diameter of the solid lubricant may preferably be equal to or smaller than the diameter of the fiber yarns. When the particle diameter of the solid lubricant is larger than the diameter of the fiber yarn, there is a liability that the large particle diameter of the solid lubricant leads to a lowering in fiber strength. Further, even in the case where the solid lubricant particles are detached from the fiber yarns, when the particle diameter is small, the solid lubricant particles remain between fiber yarns of the surface layers of the end portion seals 300 and 400, so that the small particle diameter is preferred for maintaining the effect of the present invention. In the embodiment 1, as an example of the solid lubricant particle material, the boron nitride is used. A number average diameter of the boron nitride is made 0.1 μm or more and 20 μm or less.

### Manufacturing Method of Lubricant Containing Fiber Yarns

As a method in which the solid lubricant particles are incorporated in and fixed to the fiber yarns in advance, there is a method in which a resin pellet and the solid lubricant particles are mixed in advance and then are melt-kneaded and spun. Further, there is a method in which a resin containing the solid lubricant particles in advance is melted in a resin and then is spun, and in that case, a method in which a master batch containing the solid lubricant particles in a high concentration is also included. Further, there is a method or the like in which the solid lubricant particles are added from during a step of melt-kneading a resin and then are spun. Further, there is also a method in which a mixture in a state in which a resin and the solid lubricant particles are melted in an organic solvent is extruded in a yarn-like shape in a high-temperature environment and then is spun into fiber yarns. Further, as another method, there is a method in which the solid lubricant is contacted to spun fiber yarns in a softened state by heating, and then is cooled and fixed to the fiber yarns. Further, there is a method in which spun fiber yarns are contacted to the solid lubricant particles in a state in which the spun fiber yarns are contacted to a solvent for softening the spun fiber yarns, and thus are fixed. Further, as another method, there is a method in which the solid lubricant is fixed to particles by bringing fiber yarns into contact with a liquid in which the solid lubricant particles are dispersed. In this case, from a viewpoint of fixing stability of the solid lubricant to the fiber yarns, the liquid is preferred to have viscosity and adhesiveness.

### Manufacturing Examples of Fiber Yarns (Yarns) into which Solid Lubricant is Kneaded

### Manufacturing Example

A mixture obtained by well mixing a polyester resin pellet (first resin pellet) and boron nitride of 0.6 μm in average particle diameter in a weight ratio of 100:5 in advance is melt-kneaded by a melt-kneading machine, so that a resin pellet (second resin pellet) containing the boron nitride in the polyester resin is prepared. By using this resin pellet, spinning was performed, so that yarns of about 15 μm in yarn diameter were prepared.

### Manufacturing Example

A mixture obtained by well mixing a polyester resin pellet (first resin pellet) and boron nitride of 7 μm in average particle diameter in a weight ratio of 100:8 in advance is melt-kneaded by the melt-kneading machine, so that a resin pellet (second resin pellet) containing the boron nitride in the polyester resin is prepared. By using this resin pellet, spinning was performed, so that yarns of about 25 μm in yarn diameter were prepared.

### Manufacturing Example

A mixture obtained by well mixing a polyester resin pellet (first resin pellet) and melamine cyanurate of 2 μm in average particle diameter in a weight ratio of 100:8 in advance is melt-kneaded by the melt-kneading machine, so that a resin pellet (second resin pellet) containing the melamine cyanurate in the polyester resin is prepared. By using this resin pellet, spinning was performed, so that yarns of about 25 μm in yarn diameter were prepared.

### Manufacturing Example

A mixture obtained by well mixing a nylon resin pellet (first resin pellet) and boron nitride of 0.6 μm in average particle diameter in a weight ratio of 100:5 in advance is melt-kneaded by the melt-kneading machine, so that a resin pellet (second resin pellet) containing the melamine cyanurate in the polyester resin is prepared. By using this resin pellet, spinning was performed, so that yarns of about 15 μm in yarn diameter were prepared.

### Manufacturing Example

A mixture obtained by well mixing a polyester resin pellet (first resin pellet) and dimethyl silicone oil in a weight ratio of 100:3 in advance is melt-kneaded by the melt-kneading machine, so that a resin pellet (second resin pellet) containing the dimethyl silicone oil in the polyester resin is prepared. By using this resin pellet, spinning was performed, so that yarns of about 15 μm in yarn diameter were prepared.

### Manufacturing Example of Yarns in which Solid Lubricant is Contained by a Solvent Method

### Manufacturing Example

A solution obtained by dissolving an acrylic resin and boron nitride of about 0.6 μm in average particle diameter in a weight ratio of 100:5 by acrylonitrile was formed in a yarn-like shape in a high-temperature environment and then a solvent was vaporized, so that yarns containing the boron nitride in the acrylic resin and of about 15 μm in diameter were prepared.

### Manufacturing Example of Yarns of which Surfaces are Fixed with Solid Lubricant

### Manufacturing Example

Yarns manufactured by a polyester resin and of about 15 μm in diameter were passed through an oven of 280° C., and in a state in which surfaces of the yarns were put in a softened state, the yarns were passed through inside a container in which boron nitride of 0.6 μm in average particle diameter was placed, so that yarns of which surfaces were fixed with the boron nitride were prepared.

### Manufacturing Example

Yarns manufactured by a polyester resin and of about 15 μm in diameter were passed through the oven of 280° C., and in a state in which surfaces of the yarns were put in a softened state, the yarns were passed through inside a container in which melamine cyanurate of 2 μm in average particle diameter was placed, so that yarns of which surfaces were fixed with the melamine cyanurate were prepared.

### Manufacturing example

Yarns manufactured by an acrylic resin and of about 15 μm in diameter were passed through the oven of 250° C., and in a state in which surfaces of the yarns were put in a softened state, the yarns were passed through inside a container in which boron nitride of 0.6 μm in average particle diameter was placed, so that yarns of which surfaces were fixed with the boron nitride were prepared.

### Manufacturing Example

Yarns manufactured by a nylon resin and of about 15 μm in diameter were passed through the oven of 250° C., and in a state in which surfaces of the yarns were put in a softened state, the yarns were passed through inside a container in which boron nitride of 0.6 μm in average particle diameter was placed, so that yarns of which surfaces were fixed with the boron nitride were prepared.

### Manufacturing Example of Yarns of which Surfaces were Fixed with Solid Lubricant (With Use of Liquid)

### Manufacturing Example

Yarns manufactured by a polyester resin and of about 15 μm in diameter were passed through a liquid of silicone oil in which boron nitride of 0.6 μm in average particle diameter was dispersed, so that yarns of which surfaces were fixed with the boron nitride were prepared. Incidentally, the resin materials of the fibers, the kinds and the particle diameters of the solid lubricants, and the manufacturing methods are not limited to those in the above-described examples.

### First Yarns in which Solid Lubricant is Kneaded

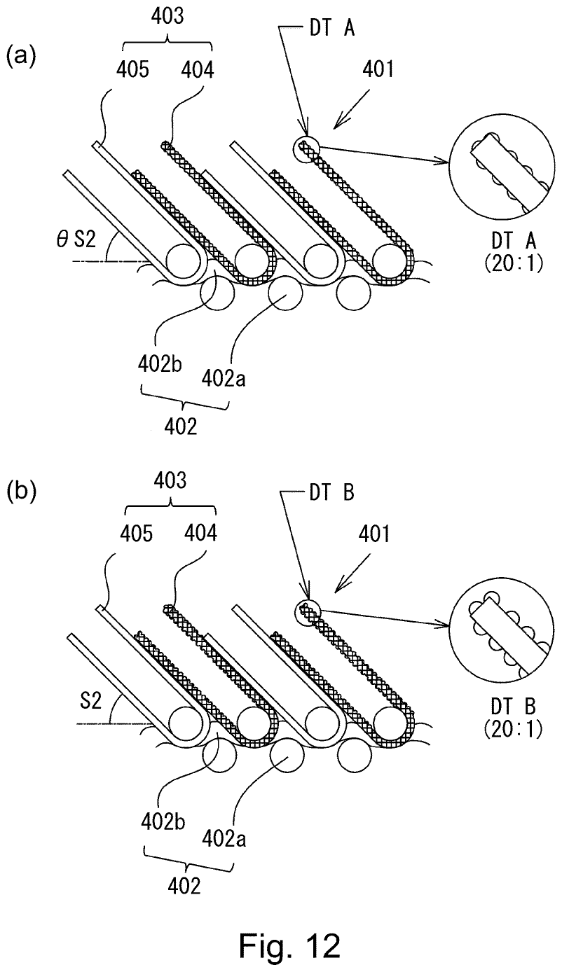

Part (a) of FIG. 12 is a view showing fiber yarns manufactured by the above-described manufacturing example of the fiber yarns (yarns) in which the solid lubricant was kneaded. To constitutions similar to those in FIG. 11, the same symbols are added. When the lubricant containing fiber yarns 404 are manufactured by kneading the solid lubricant therein, as shown by a solid line circle DTA of part (a) of FIG. 12, by the solid lubricant 404a, uneven shape appears on surfaces of the lubricant containing fiber yarns 404. Here, a state in which an about 10% to 50% of the solid lubricant relative to an average particle volume of the solid lubricant is exposed to fiber surfaces is formed. As regards what % of the solid lubricant is exposed, it is possible to make measurement by electron microscope observation such as SEM or TEM. An image is captured when the measurement is performed, and a resultant image is analyzed and conversion is performed on the basis of magnification, so that a dimension such as the particle diameter can be measured. On the basis of a result that this measurement of the dimension is performed a plurality of times, an average particle volume of a portion where the particles are exposed is calculated by calculation. Instead of the capture of the image, by using a dimension obtained by printing a photograph and then by measuring a print with a ruler, the dimension such as the particle diameter may also be calculated on the basis of magnification during the measurement.

### First Yarns in which Solid Lubricant is Contained by Solvent Method

Part (b) of FIG. 12 is a view showing fiber yarns manufactured by the above-described manufacturing example of the fiber yarns (yarns) in which the solid lubricant was contained by the solvent method. To constitutions similar to those in FIG. 11, the same symbols are added. When the lubricant containing fiber yarns 404 are manufactured by kneading the solid lubricant therein, as shown by a solid line circle DTB of part (b) of FIG. 12, by the solid lubricant 404b, uneven shape appears on surfaces of the lubricant containing fiber yarns 404. Incidentally, as shown in FIG. 12, a degree of projection is larger in the case where the solvent method was used than in a kneading method. Here, a state in which an about 40% to 80% of the solid lubricant relative to an average particle volume of the solid lubricant is exposed to fiber surfaces is formed. This can also be measured similarly as the fiber yarns in which the solid lubricant was kneaded.

Incidentally, also in the manufacturing examples of the yarns of which surfaces were fixed with the solid lubricant and in the manufacturing example of the yarns of which surfaces were fixed with the boron nitride (with use of a liquid), the lubricant containing fiber yarn 404 as shown in part (b) of FIG. 12 was manufactured.

Thus, by kneading the solid lubricant or by containing the solid lubricant by the solvent method, about 10% or more and 80% or less of the solid lubricant relative to an average particle volume is in a state of being exposed to the fiber surfaces. When the solid lubricant is kneaded into the yarns, about 10% or more and 50% or less of the solid lubricant relative to the average particle volume is in the state of being exposed to the fiber surfaces, and when the solid lubricant is contained into the yarns by the solvent method, about 40% or more and 80% or less of the solid lubricant relative to the average particle volume is in the state of being exposed to the fiber surfaces.

### Application of Solid Lubricant to Solid Lubricant Containing Fiber Yarn

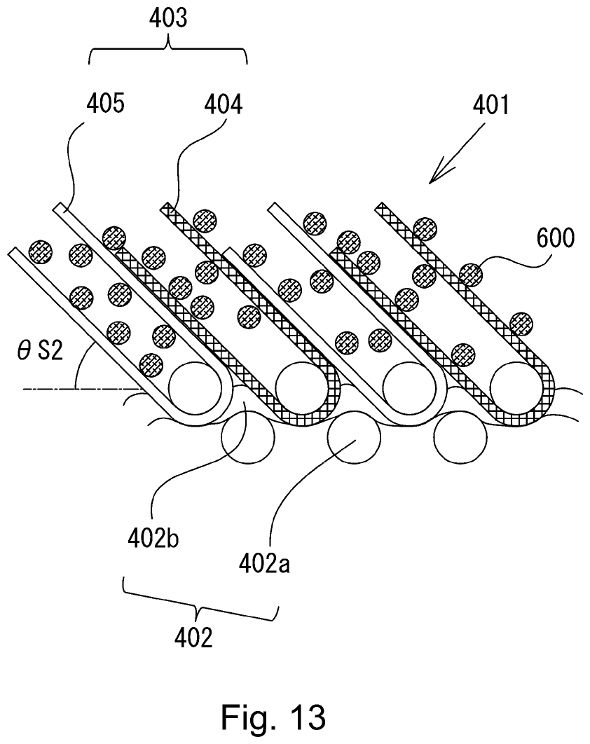

In the embodiment 1, the fiber layer using the fiber yarns containing the solid lubricant for the purpose of improving the sliding performance and the temperature rise suppressing performance which relative to the toner sealing performance of the end portion seals 300 and 400 was described, but a lubricant may also be further applied. When the solid lubricant contained in the fiber yarns is a first solid lubricant, a second solid lubricant is further applied onto the fiber surface layer. FIG. 13 is an illustration in which a lubricant is further applied onto the end portion seal 400 of FIG. 11, and to constitutions similar to those of FIG. 11, the same symbols are added. Incidentally, the same also applies to the end portion seal 300.

As described above, the surface layer of the end portion seal 400 rubs the photosensitive drum 4 and the developing roller 6. For that reason, there is a liability that the fibers of the surface layer are gradually abraded, and the lubricant containing fiber yarns 404 are abraded, so that there is a possibility that the sliding performance and the temperature rise suppressing performance are lowered. For that reason, by further applying lubricant particles 600, even in the case where the effect of the lubricant containing fiber yarns 404 is lowered, the application of the lubricant particles 600 can lead to the lifetime extension of the process cartridge P.

A constitution in which the lubricant particles 600 are applied to the surface layer of the end portion seal 400 containing only the lubricant non-containing fiber yarns 405 would also be considered. However, there is a liability that the lubricant particles 600 are not moved from the inside of each toner accommodating portion or from on the end portion seal 400 together with the toner to be transferred, by the rotation of the photosensitive drum 4 and the developing roller 6. For that reason, it is desirable that the lubricant particles 600 are further applied while using the lubricant containing fiber yarns 404.

Here, application is made using, as the lubricant particles 600 applied to the lubricant containing fiber yarns 404, the boron nitride and the zinc stearate which are the above-described solid lubricants, and TOSPEARL which is silicone resin particles, or the like. As an application method, a liquid in which a particulate material is dispersed in isopropyl alcohol is applied onto the surface of the end portion seal 400 and the isopropyl alcohol is vaporized, so that the particulate material is applied to the surface of the end portion seal 400. Incidentally, as the lubricant to be applied, other solid lubricants, other liquid lubricants, or other particles may also be applied.

As the solid lubricant to be applied, it is preferred to select a material having the same kind and the same particle diameter as those of the solid lubricant contained in the above-described lubricant containing fiber yarns 404. However, other materials and other particle diameters may also be used. As a timing of the application, during assembling of the drum unit 8 and the developing unit 9, or an end portion seal to which the solid lubricant is applied may only be required to be prepared in advance.

As one of methods for preventing seal surface abrasion such that the surface of the end portion seal is abraded or for preventing that the developer enters due to sliding friction between each of the cleaning-side end portion seal and the development-side end portion seal (which are referred to as a toner seal or the end portion seal as a general term) and each component part, by realizing speed-up and lifetime extension of the image forming apparatus, there is a method in which the particulate material is applied onto a seal surface. Only by applying the particulate material, there is a liability that due to the speed-up and the lifetime extension, the particulate material gradually comes off or scatters from the seal surface. In this case, there is a liability that the toner sealing performance by the end portion seal cannot be achieved and toner leakage is caused. Further, in the case where the toner caught by the surface of the end portion seal is fused when the toner is lowered in melting point, there is also a liability that the toner sealing performance by the end portion seal cannot be achieved and the toner leakage is caused, but durability of the cartridge can be improved by the constitutions described above.

As described above, according to the embodiment 1, the toner sealing performance in the end portions of the cartridge with respect to the longitudinal direction is improved, and by extension, durability can be improved. According to the embodiment 1, it is possible to provide a developing device including an end portion seal in a new configuration.

### INDUSTRIAL APPLICABILITY

According to the present invention, the seal member, the toner carrying device provided with the seal member, and the image forming apparatus are provided.

The present invention is not limited to the above-described embodiments, but can be variously changed and modified without departing from the spirit and the scope of the present invention. Accordingly, the following claims are attached for making the scope of the present invention public.

The present application claims priority on the basis of Japanese Patent Application Nos. 2023-166834 filed on Sep. 28, 2023, which is hereby incorporated by reference herein in its entirety.

1. A toner carrying device used in an image forming apparatus, comprising:
a rotatable member rotatable and constituted so as to carry toner;
a frame for rotatably supporting the rotatable member; and
a seal member for sealing a gap between an end portion of the rotatable member in a longitudinal direction of the rotatable member and the frame,
wherein the seal member includes a surface layer portion contacting the rotatable member, and
wherein the surface layer portion contains a fiber yarn to which particles of a solid lubricant are fixed.

2. The toner carrying device according to claim 1, wherein the particles enter an inside of the fiber yarn so that a part thereof is exposed from a surface of the fiber yarn.

3. The toner carrying device according to claim 1, wherein the surface layer portion includes a base material, and on the base material, the fiber yarn is provided in plurality.

4. The toner carrying device according to claim 1, wherein the rotatable member is a photosensitive drum constituted so as to carry a toner image, and
wherein the frame is a toner accommodating portion for accommodating the toner collected from the photosensitive drum.

5. The toner carrying device according to claim 1, wherein the rotatable member is a developing roller for supplying the toner to a photosensitive drum, and
wherein the frame includes a toner accommodating portion for accommodating the toner for being carried by the developing roller.

6. The toner carrying device according to claim 1, wherein the solid lubricant is boron nitride.

7. The toner carrying device according to claim 6, wherein the boron nitride is 0.1 μm or more and 20 μm or less in number average diameter.

8. The toner carrying device according to claim 2, wherein a portion corresponding to 10% or more and 80% or less of an average volume of the particles is exposed from the surface of the fiber yarn.

9. The toner carrying device according to claim 2, wherein the fiber yarn is a fiber yarn spun from a second resin pellet formed by melting and kneading a mixture in which a first resin pellet and the particles are mixed.

10. The toner carrying device according to claim 2, wherein the fiber yarn is a fiber yarn of which surface is fixed with the particles by passing a yarn comprising a polyester resin through silicone oil in which the particles are dispersed.

11. The toner carrying device according to claim 9, wherein a portion corresponding to a volume which is 10% or more and 50% or less of an average volume of the particles is exposed from the surface of the fiber yarn.

12. The toner carrying device according to claim 10, wherein a portion corresponding to a volume which is 40% or more and 80% or less of an average volume of the particles is exposed from the surface of the fiber yarn.

13. The toner carrying device according to claim 3, wherein when the solid lubricant is a first solid lubricant,
to the surface layer portion, a particulate material of a second solid lubricant different from the first solid lubricant is applied.

14. The toner carrying device according to claim 13, wherein the second solid lubricant contains zinc stearate or a silicone resin.

15. The toner carrying device according to claim 1, wherein when the surface layer portion is a first layer,
the seal member includes the first layer, a second layer comprising an elastic member, a third layer for bonding the first layer and the second layer thereto, and a fourth layer for being bonded to the second layer and the frame.

16. The toner carrying device according to claim 3, wherein the base material is constituted by the fiber yarn.

17. The toner carrying device according to claim 8, wherein the surface layer portion is constituted by a knitted fabric obtained by knitting the fiber yarn or nonwoven fabric containing the fiber yarn.

18. The toner carrying device according to claim 8, wherein the surface layer portion is constituted by a base material planted with the fiber yarn by electrostatic planting.

19. The toner carrying device according to claim 1, wherein a material of the fiber yarn is any one of polyester, nylon, acrylic, rayon, and polyolefin.

20. The toner carrying device according to claim 1, wherein when the fiber yarn is first fiber yarn,
the surface layer portion contains a second fiber yarn to which the particles are not fixed.

21. The toner carrying device according to claim 20, wherein a material of the first fiber yarn is any one of polyester, nylon, acrylic, rayon, and polyolefin, and
wherein a material of the second fiber yarn is any one of polytetrafluoroethylene, perfluoroalkoxy alkane, and ethylene tetrafluoroethylene.

22. An image forming apparatus comprising the toner carrying device according to claim 1.

23. A seal member used for sealing a gap between a rotatable member for carrying toner in an image forming apparatus and a frame for rotatably supporting the rotatable member, the seal member comprising:
a surface layer containing a fiber yarn to which particles of a solid lubricant are fixed.
